(19) United States
(12) Patent Application Publication
(10) Pub. No.: US 2013/0220651 A1
(43) Pub. Date: Aug. 29, 2013

(54) FIRE-EXTINGUISHER HAVING CONTAINERS FOR ADDITIVES

(71) Applicants: Said RACHIDI, Hyon (BE); Hicham DAMSIR, Jeumont (FR)

(72) Inventors: Said RACHIDI, Hyon (BE); Hicham DAMSIR, Jeumont (FR)

(73) Assignee: CERTECH a.s.b.l., Seneffe (BE)

(21) Appl. No.: 13/408,341

(22) Filed: Feb. 29, 2012

(51) Int. Cl. A62C 13/66; A62C 13/76

(52) U.S. Cl. 169/85; 169/91

(57) ABSTRACT

An extinguisher has a cylinder capable of containing a fire-extinguishing product, and means for releasing the fire-extinguishing product from the cylinder and comprising at least one compressed gas cartridge, at least two tanks, each capable of containing at least one additive product, and means for releasing at least one additive product from each of the at least two tanks and for mixing with the fire-extinguishing product during the release of the fire-extinguishing product. At least one of the tanks is removable relative to the extinguisher. A cartridge having a plurality of tanks is usable in the extinguisher.

### TECHNICAL FIELD

The invention relates to the field of fire extinguishers. More particularly, the invention relates to an extinguisher comprising a cylinder capable of containing a fire-extinguishing product, means for releasing the fire-extinguishing product from the cylinder and comprising at least one compressed gas cartridge, at least two tanks each capable of containing at least one additive product and means for releasing the at least one additive product from the at least two tanks and mixing with the fire-extinguishing product when the fire-extinguishing product is released. The invention also relates to cartridges for an extinguisher and the use of such cartridges.

### DESCRIPTION OF THE PRIOR ART

Different types of extinguisher are on the market. They may be classified according to the type of fire-extinguishing product which they use: water, foam, powder or gas (carbon dioxide) extinguishers. The use of one type of extinguisher relative to another essentially depends on the material in combustion. Water extinguishers are used for class A fires, foam and gas extinguishers for class A or B fires. Powder extinguishers in turn may be used for class A and B, A B and C, or D fires. The formulations in the extinguisher also vary depending on the type of extinguisher.

The known extinguishers comprise a tank, for example a cartridge, containing all the additive products. Said tank is generally arranged inside the cylinder.

A water extinguisher is disclosed in the patent EP 0 461 020, said water extinguisher comprising a cartridge for fire-extinguishing additives. Said patent discloses a cartridge containing additives capable of improving the fire-extinguishing properties of water and comprising an oblong, rigid tubular body with an open end, said end being sealed by a cap provided to be torn at a specific external pressure which is lower than the maximum pressure to which the water is subjected after the release of the propulsive gas. The cartridge comprises a compartment containing the additives.

More recently, extinguishers containing a plurality of chambers for additives have been disclosed. Thus, an extinguisher comprising a percussion head is disclosed in FR 2 722 416, and a protective tube in which is arranged a gas capsule and two chambers for receiving additives fixed in a permanent manner to the protective tube. The chambers for receiving additives are not accessible separately by the user. An extinguisher comprising two external tanks fixed to the body of the cylinder of the extinguisher is also disclosed in EP 1 935 458. Said arrangement requires the use of numerous connectors to connect the additive compartments, the compressed gas cartridge and the inside of the cylinder.

The cartridges for additives present in extinguishers have a use-by date. In the majority of cases the cartridges have not been used before said use-by date and thus have to be changed. The unused cartridges are combusted without establishing a recycling schedule or specific treatment of the additives present in said cartridge. However, some of said additives are pollutant or dangerous for the environment. The recycling of said known cartridges or their contents is not easy, given their configuration or their position relative to the cylinder of the extinguisher. Changing said cartridges may thus prove to be dangerous and costly. There is a need for an extinguisher which enables improved recycling of the cartridges containing the additives.

The invention proposes to remedy the drawbacks mentioned above, whilst maintaining the advantages of the known cartridges.

### SUMMARY OF THE INVENTION

According to a first aspect, the present invention provides an extinguisher comprising at least two tanks each capable of containing at least one additive product and means for releasing the at least one additive product from each of the at least two tanks, and wherein at least one of the tanks is removable relative to the extinguisher. The term “at least one tank” is considered to encompass in particular the terms “one or more than one tank” and “a plurality of tanks”. Preferably, said at least two tanks are removable relative to the extinguisher. The term “removable relative to the extinguisher” means that the tanks may be detached or removed from the extinguisher to form an element which is separate, removed or disconnected from said extinguisher. The term “at least two tanks” is considered to encompass in particular the terms “two or more than two tanks” and “a plurality of tanks”. The presence of a plurality of tanks each capable of containing one or more additives makes it possible to partition the additives in the different tanks. Thus, it is possible to fill the different tanks depending on the ultimate goal desired, in terms of recycling or treatment of said additives. For example, it is possible to arrange inside a first tank one or more additives which are classified as highly pollutant for the environment and able to be treated or recycled separately according to the same procedure. A second tank could, for example, contain one or more additives which are non-pollutant and do not require treatment or recycling. It is also possible to separate the additives into the different tanks depending on their chemical structure, for example to separate the fluorinated additives and the non-fluorinated additives or separate the long chain hydrocarbons from the shorter chain hydrocarbons. The presence of tanks which are able to be removed relative to the extinguisher makes it possible to remove or detach the tank(s) from the extinguisher and to treat them separately according to a precise recycling schedule. The tanks containing the additive products may thus be accessible directly to the user who is in charge of monitoring correct operation of the extinguisher.

In embodiments, the at least two tanks are arranged inside the cylinder. The arrangement of the tanks inside the cylinder facilitates their use in several types of extinguisher. Said embodiment avoids the use of a complex connection between the tank and the fire-extinguishing product.

In another embodiment, said at least two tanks are disconnected. Thus, the tanks may be treated or recycled separately from one another. For example, if one of the tanks contains an additive product of which the use-by date is shorter than that of the additive product container in the second tank, only the tank with the out-of-date contents may be removed from the extinguisher.

Alternatively, the at least two tanks are provided with means to be connected together by their end or by their lateral wall. Thus, the tanks may be connected together and rearranged in a restricted space of the extinguisher. The mixture of the additive products and the fire-extinguishing product will be more homogeneous. Moreover, said embodiment facilitates the clamping of the tanks and the subsequent separation thereof.

According to a further alternative embodiment, at least one of the tanks has a lateral wall connected to a further tank, preferably to the lateral wall of a further tank, more preferably at least one of the tanks has a lateral wall at least partially common with a lateral wall of a further tank.

According to a second aspect, the invention relates to a cartridge for an extinguisher, said cartridge comprising a plurality of tanks, said tanks comprising one or more additives capable of improving the properties of the fire-extinguishing product. In an embodiment, at least one of the tanks is removable relative to the cartridge. The term “removable relative to the cartridge” means that the tank may be detached or removed from the cartridge to form an element which is separate, removed or disconnected from said cartridge. Alternatively, said tanks are fixed relative to the cartridge. Thus, said tanks may have a lateral or upper wall which is at least partially common with that of the cartridge. Said alternative configuration also makes it possible to provide separate tanks, of which the lower opening is accessible directly to a user wishing to remove or modify the contents of the tanks or to fill said tanks with a solution of freshly prepared additive products.

According to a third aspect, the invention relates to the use of said cartridge in an extinguisher.

Said embodiment and further embodiments of the invention will be clarified in the detailed description of embodiments of the invention, reference being made to the drawings of the following figures.

### BRIEF DESCRIPTION OF THE DRAWINGS

FIGS. 1a-c show schematically cross sections of extinguishers according to an embodiment of the present invention.

FIG. 2 shows a schematic view of a tank according to an embodiment of the present invention.

FIG. 3 shows a schematic view of two tanks assembled together according to an embodiment of the present invention.

FIG. 4 shows a schematic view of a cartridge comprising two tanks according to an embodiment of the present invention.

FIG. 5 shows a schematic view of a cartridge comprising four tanks according to an embodiment of the present invention.

FIG. 6 shows a schematic view of a cartridge comprising two tanks according to an embodiment of the present invention.

### DETAILED DESCRIPTION OF THE INVENTION

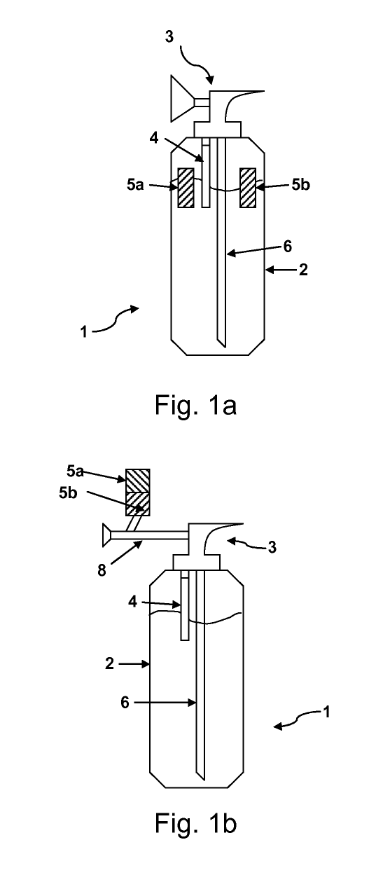

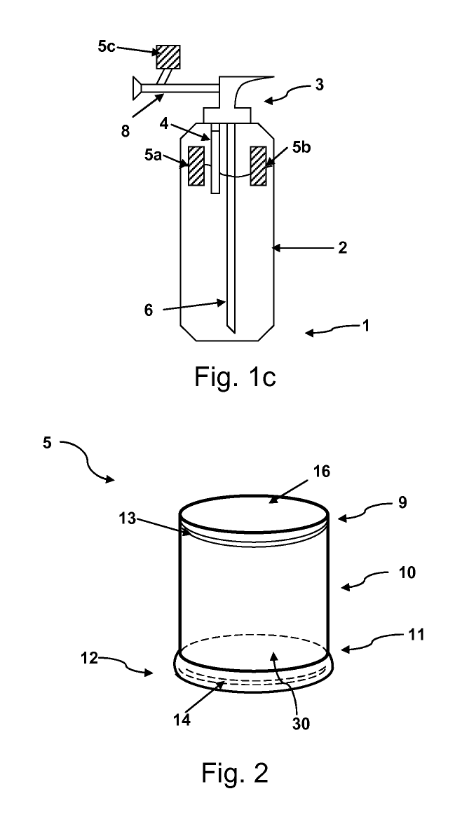

According to a first embodiment, the present invention relates to an extinguisher. FIG. 1a shows schematically a cross section of an embodiment of an extinguisher according to the present invention. The extinguisher 1 has a cylinder 2 able to be filled with a fire-extinguishing product, such as for example water. The extinguisher 1 also has means for releasing the fire-extinguishing product from the cylinder. Thus, the cylinder is surmounted by an ejection head 3 connected to a tube 6 immersed in the cylinder 2. A container of propulsive compressed gas 4 is connected to the ejection head 3. The extinguisher also may have at least one tank 5, such as, for example, a first tank 5a (hereinafter “tank 5a”) and a second tank 5b (hereinafter “tank 5b”) arranged inside the cylinder 2. The first tank 5a and/or second the tank 5b (collectively known hereinafter as “the tanks 5a, 5b”) are capable of containing one or more additives capable of improving the fire-extinguishing properties of the fire-extinguishing product. The tanks 5a, 5b are removable relative to the extinguisher. The tanks 5a, 5b are disconnected. The tanks 5a, 5b may be held by fixing means (not shown in FIG. 1a), for example by means of a hook, on the cylinder 2, or on a further element of the extinguisher. The tanks 5a, 5b may also be mobile relative to the cylinder 2. More specifically, the tanks 5a, 5b may be displaced inside the cylinder 2. The fixing means make it possible to stabilize at least one of the tanks 5a, 5b inside the cylinder 2 whilst promoting its ultimate removal. When the cylinder is filled with the fire-extinguishing product, at least the lower part of the tanks 5a, 5b is immersed in the fire-extinguishing product. To use the extinguisher 1, the user has to actuate the ejection head 3 of the extinguisher 1 to permit the release of propulsive gas inside the cylinder 2. Under the action of the differential pressure, means permit the release of the at least one additive product from the tank 5a and the at least one additive product from the tank 5b. The additive products are thus mixed with the fire-extinguishing product. Said mixture is then ejected by the tube 6 toward the ejection head 3. If the extinguisher is not used, the tanks 5a, 5b may be easily removed from the cylinder 2 and thus from the extinguisher, to be replaced by further tanks containing, for example, a new formulation. The contents of the tank 5a may also be removed by the user and replaced by a freshly prepared solution. The removable nature of the tanks 5a, 5b thus permits the easy recycling of said tanks 5a, 5b and their contents. The embodiment of the invention may also make it possible to adapt easily existing extinguishers and does not require the replacement or modification of the connectors of existing extinguishers.

The means permitting the release of at least one additive from the first tank 5a and the second tank 5b may, for example, be sealed closing means arranged on the corresponding tanks which at a specific differential pressure permit the release of the additive products. The differential pressure is usually between 0.2 MPa and 0.8 MPa, preferably between 0.3 MPa and 0.5 MPa. Thus, said sealed closing means may be independently a cap capable of rupturing or a valve capable of being opened at a differential pressure of between 0.2 MPa and 0.8 MPa, preferably between 0.3 MPa and 0.5 MPa.

The at least two tanks 5a, 5b may be arranged outside and/or inside the cylinder 2 of said extinguisher 1. FIG. 1b shows a cross section of an extinguisher according to an embodiment of the present invention in which the tanks 5a, 5b are arranged outside the cylinder 2. A discharge pipe 8 for the fire-extinguishing product is connected to the tanks 5a, 5b assembled together. FIG. 1c shows a cross section of an extinguisher according to an embodiment of the present invention in which a third tank 5c (hereinafter “tank 5c”) is connected to the discharge pipe 8 of the ejection head 3 and the tanks 5a, 5b are arranged inside the cylinder 2. The number of tanks or the arrangement thereof in FIGS. 1a-c is not limiting. The person skilled in the art will understand that further configurations of the extinguisher may be conceivable. For example, at least one of the tanks 5 is arranged inside the cylinder 2. In another example, the at least two tanks 5a, 5b are arranged inside the cylinder 2.

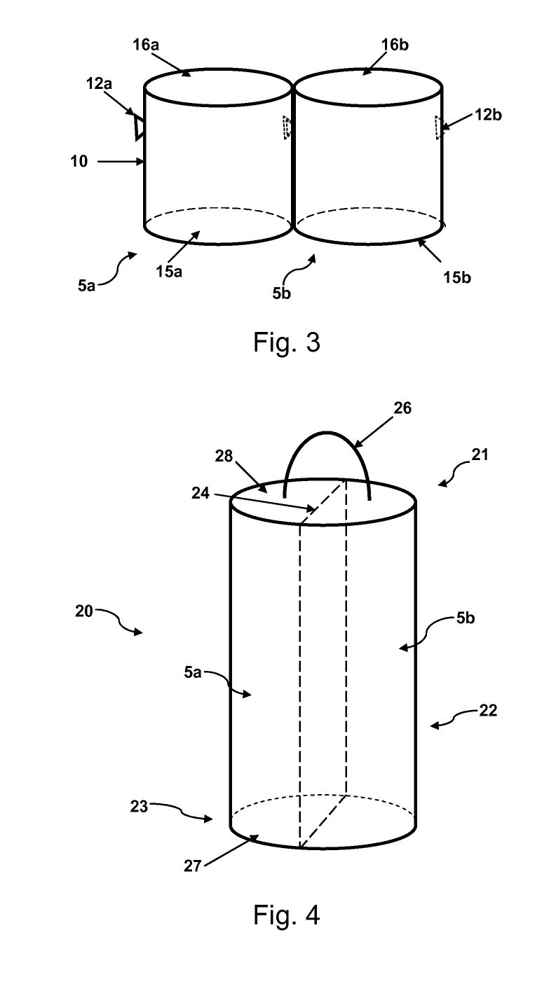

According to an embodiment, the at least two tanks 5a and 5b are provided with means to be connected together in a removable manner. This may facilitate, for example, their arrangement inside the cylinder 2. Said means may, for example, be a threaded portion, a tapped portion, a male-female tab/notch system or a clip. FIG. 2 shows a schematic view of a tank 5 according to an embodiment of the present invention. Said tank 5 has an upper part 9, a lateral wall 10 and a lower part 11. The lower part 11 of the tank 5 comprises a lower opening 30. The lower part 11 of the tank 5 has a fixing means 12 making it possible to connect said tank 5 to a further tank. Said fixing means is a tapped portion 14. The upper part 9 of the tank 5 has a threaded portion 13. Thus, the tapped portion 14 makes it possible to assemble the tank 5 with a second tank having a threaded portion on its upper part. Said at least two tanks 5a, 5b may also be connected together by their end or their lateral wall. The term “end” is understood as the upper part and the lower part of a tank. Thus the lower wall of the first tank 5a may be connected to the upper part of a second tank 5b. The lower part of the second tank 5b or the upper part of the first tank 5a may be connected respectively to the upper part or lower part of the third tank 5c. When the tanks 5a, 5b are superposed, the lower part 11 of a single tank may be immersed in the fire-extinguishing product. FIG. 3 shows a schematic view of the tanks 5a and 5b assembled together by their lateral wall 10 using a fixing means represented by a male-female tab/notch system 12a, 12b. More specifically, each tank of the tanks 5a, 5b may have a male tab 12a and a female notch 12b permitting the assembly of the two tanks. The tabs/notches may be located in any manner over the entire surface of the lateral wall. Said embodiment may have the advantage of permitting an ejection of the additive products simultaneously and non-sequentially into the fire-extinguishing product. The tanks 5a, 5b may possibly have a second fixing means on their upper and/or lower part, for example a threaded portion permitting the assembly of further tanks above and/or below said tanks.

The tanks 5a, 5b may be provided with a lower sealed closing means and an upper sealed closing means. As shown in FIG. 3, the tanks 5a, 5b have a sealed closing means 15a, 15b on their lower part and a sealed closing means 16a, 16b on their upper part. The lower sealed closing means 15a, 15b may be capable of closing the lower opening 30 of the tank 5. Said lower sealed closing means 15a, 15b are, for example, caps. Said caps may be made of aluminum, polyethylene or any other polymer capable of forming a polymeric film capable of rupturing at a differential pressure of between, for example, 0.2 MPa and 0.8 MPa, preferably between 0.3 MPa and 0.5 MPa to permit the release of the additive products. Said lower sealed closing means may be configured to permit the replacement of the additive products of the tank 5. For example, in the case of caps, the user is able to remove the cap, change the solution of the additive products, then position a further cap to close the lower opening 30 of the tank 5. In the embodiment of FIG. 3, the upper sealed closing means 16a and 16b are not configured to rupture within the aforementioned differential pressure range. Said upper sealed closing means 16a, 16b may be made of the same material as the lateral wall of said tank, such as for example high density polyethylene (HDPE), whether recycled or not. Alternatively, said lower and upper sealed closing means 15, 16 may be configured to permit the release of the additive products.

The sealed closing means may be adapted according to the assembly of said tanks 5a, 5b. When said tanks 5a, 5b are stacked on top of one another, the tank located at the top may contain an upper sealed closing means which is configured not to permit the release of the additive products, in contrast to the lower sealed closing means of said tank located at the top and to the further sealed closing means of the further tanks. Alternatively, when the tanks 5a, 5b are assembled via their lateral wall, only the lower sealed closing means are configured to permit the release of the additive products.

According to an embodiment, at least one tank is arranged inside a cartridge 20, thus forming at least one separate compartment inside said cartridge 20. Said embodiment has the advantage of subsequently reusing said cartridge, the walls thereof not having been contaminated by the additives. Said cartridge 20 comprises a lateral wall 22, an upper part 21 and a lower part 23. The lower part 23 of the cartridge 20 is that which is in contact with the liquid of the cylinder 2 of the extinguisher 1 or that connected to the discharge pipe 8 of the extinguisher 1. Said at least one tank 5 is removable relative to the cartridge 20. In an embodiment, at least two tanks 5a, 5b are arranged inside said cartridge 20, thus forming a plurality of compartments inside said tanks. Each tank 5 may thus be arranged independently of the others. Preferably, said at least two tanks 5a, 5b are removable relative to the cartridge 20. The lower opening 30 of each tank may be directly accessible. Thus a user may easily remove or change the additive product contained in the tank 5.

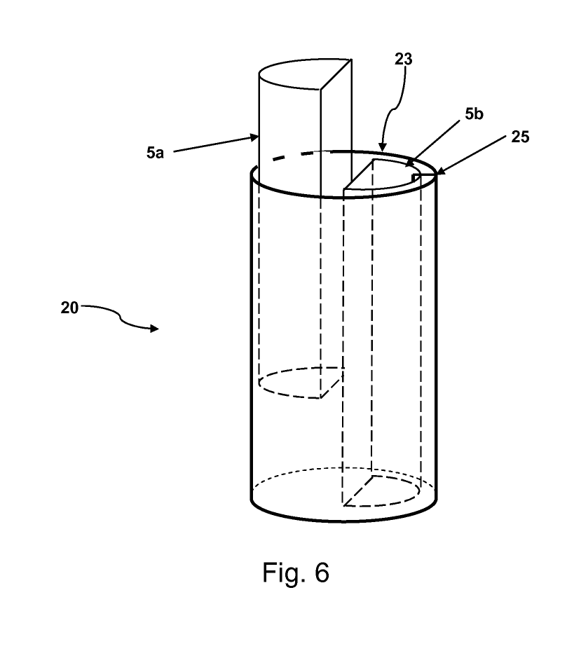

FIG. 6 shows a schematic view of a cartridge 20 comprising the tanks 5a, 5b. The tanks 5a, 5b are removable relative to the cartridge 20. Moreover, the tanks 5a and 5b may be mobile relative to the cartridge 20. Said tanks 5a, 5b are preferably immobilized inside the cartridge 20 via an immobilizing means 25 placed, for example, on the lower part 23 of said cartridge 20. The means for immobilizing the tank 5a are not shown. A modification of the positioning of said blocking means 25 makes it possible to remove the tanks 5a, 5b. The removal of a tank is independent of the removal of the other tank present in the cartridge. The subsequent treatment of the tank may thus be facilitated.

According to an embodiment of the invention, at least one of the tanks 5 arranged inside the cartridge 20 has a wall at least partially common with a wall of said cartridge 20. Preferably, the lateral or upper wall of said at least one of the tanks 5 and said cartridge 20 are at least partially common. For example, the upper part and the lateral wall of said at least one of the tanks 5a, 5b and said cartridge 20 are at least partially common.

In an embodiment, at least one part of the lateral wall of a first tank 5a arranged inside the cartridge 20 is common with the lateral wall of a second tank 5b arranged inside the cartridge 20. A separating means is thus formed between said first and second tanks 5a, 5b by the common part of their lateral wall. When the extinguisher comprises at least two tanks 5 inside the cartridge 20, said at least two tanks 5a. 5b may have a lateral wall at least partially common with that of said cartridge 20, and at least partially common with a lateral wall of at least one of the tanks 5a, 5b present in the cartridge 20. Preferably, each tank 5 arranged inside the cartridge 20 has a lateral wall partially common with that of said cartridge 20 and partially common with a lateral wall of at least one further tank arranged inside the cartridge 20. In this case, the lower opening 30 of each tank 5 may be directly accessible. Moreover, when the extinguisher is used, the mixing of the additive products of each tank and the fire-extinguishing product is simultaneous.

According to an embodiment, said cartridge 20 is provided with a lower sealed closing means 27 arranged on its lower part 23. Said lower sealed closing means 27 of said cartridge 20 may be partially or entirely common with said lower sealed closing means of at least one tank or the plurality of tanks 5a, 5b. For example, said lower sealed closing means 27 of said cartridge 20 is common with said lower sealed closing means of the plurality of tanks 5a, 5b arranged inside the cartridge 20. Thus, said lower sealed closing means 27 is a closing means of at least one tank 5 or the plurality of tanks 5a, 5b. Said lower sealed closing means of the cartridge 20 and the tanks 5a, 5b may be a cap, as disclosed above. The upper sealed closing means 28 of the cartridge 20 is configured so as not to permit the release of the additive products.

The fire-extinguishing products currently in use are compositions of several derivatives able to comprise, in particular, agents forming a floating film (AFFF: aqueous film forming foam). The annual global production of AFFF is several million tons. The AFFF make it possible to form a film limiting the contact between the fuel and the oxygen. Said agents forming a floating film may contain (ionic, non-ionic or amphoteric) hydrocarbon surfactants fluorinated or perfluorinated surfactants, derivatives of glycol ether, and optionally other additives, for example biocides, anti-corrosive agents, or rheology agents. The degradation of the derivatives varies over time and is highly dependent on their chemical structure. The degradation of a single derivative of the composition requires the complete destruction thereof. It is, therefore, important to be able to separate the different components of the composition to avoid systematic degradation of the entire composition. The hydrocarbon surfactants may, for example, have a faster degradation speed than that of other derivatives which form part of the composition. Moreover, the fluorinated surfactants have a relatively harmful ecological impact in terms of their low bioassimilation and their persistence in phreatic layers. The separation of this type of component from the remainder of the composition may thus represent an economic advantage whilst reducing the costs associated with the preparation of the fire-extinguishing product. More specifically, the stable derivatives could be isolated from products having low stability and thus directed to a suitable recycling procedure. Thus, according to an embodiment, at least one of the tanks is capable of containing or contains a composition of an agent forming a floating film (AFFF). For example, at least one of the tanks 5a, 5b is capable of containing or contains one or more fluorinated or perfluorinated surfactants.

For example, the extinguisher may be a water or foam extinguisher.

According to a further aspect, the invention relates to a cartridge 20 for an extinguisher 1 wherein it may have a plurality of tanks 5a, 5b, said tanks 5a, 5b each being capable of containing one or more additives capable of improving the properties of a fire-extinguishing product. Preferably, the cartridge is located inside the cylinder 2. The cartridge 20 may be mobile relative to the extinguisher or removable relative thereto.

According to an embodiment of the invention, at least one of said tanks 5a, 5b is removable relative to the cartridge 20. The cartridge 20 may be provided with an immobilizing means 25 for at least one tank of said plurality of tanks 5a, 5b to immobilize said at least one tank inside the cartridge 20. The cartridge 20 may contain at least two tanks 5a, 5b removable relative thereto. Said at least two tanks 5a, 5b may be connected together in a removable manner. The cartridge 20 is also disclosed in detail above with reference to FIGS. 2, 3 and 6.

According to an embodiment, at least one of said tanks 5a, 5b is fixed relative to the cartridge 20. Thus, it may have a wall at least partially common with that of the cartridge 20. At least one of said tanks 5a, 5b may have a wall at least partially common with a wall of a further tank arranged in the cartridge 20. For example, at least one of said tanks 5a, 5b may have a lateral wall at least partially common with a lateral wall of a further tank arranged in the cartridge 20. The lower opening 30 of said at least one of the tanks 5a, 5b may be directly accessible. For example, when renewing the cartridge, if it contains a plurality of mobile or removable tanks, if necessary the user may remove the mobile or removable tanks, and thus have direct access to the lower opening of the fixed tank and thus to the contents thereof. If the cartridge 20 contains a plurality of fixed tanks 5a, 5b, said tanks 5a, 5b may be juxtaposed or partially superposed to maintain direct access to the lower opening 30.

According to a further embodiment of the invention, the cartridge 20 contains a plurality of tanks 5a, 5b of which at least one of the tanks 5a, 5b has a lateral wall at least partially common with a lateral wall of at least one further tank 5 arranged in the cartridge 20. The cartridge 20 may also contain at least two tanks 5a, 5b having a lateral wall at least partially common with a lateral wall of a further tank arranged inside the cartridge 20. Moreover, said at least one tank 5 may have a wall at least partially common with a wall of the cartridge 20. For example, at least two of the tanks 5a, 5b have a wall common with that of the cartridge 20. At least one part of the lateral or upper wall of one of the tanks 5a, 5b may be partially common with a lateral or upper wall of said cartridge 20. In particular, at least one of the tanks 5a, 5b has a lateral wall at least partially common with a lateral wall of the cartridge 20 and at least partially common with a lateral wall of at least one further tank 5 arranged inside the cartridge 20.

According to an embodiment, each of the tanks 5a, 5b arranged inside the cartridge 20 has a lateral wall at least partially common with a lateral wall of at least one further tank arranged inside the cartridge 20. Each of the tanks 5a, 5b arranged inside the cartridge 20 may also have a lateral wall at least partially common with a lateral wall of said cartridge 20.

Moreover, FIG. 4 shows a schematic view of a cartridge 20 having the tanks 5a, 5b according to an embodiment of the present invention. The cartridge 20 has an upper part 21, a lateral wall 22 and a lower part 23. The cartridge 20 may have the tanks 5a, 5b. The lateral walls and the lower part of the tanks 5a, 5b are in each case partially common with the lateral wall 22 and the lower part 23 of the cartridge 20. Moreover, the lateral wall of the tank 5a is partially common with the lateral wall of the tank 5b and thus forms a separating means 24 between the tanks 5a, 5b. The separating means 24 is a polymer membrane. The membrane may be formed from HDPE, whether recycled or not, or any other material guaranteeing the seal between the tanks 5a, 5b and not interacting with the additive products. Said embodiment of the cartridge 20 may be easily made by extrusion or injection-molding, keeping down the production costs. Moreover, said embodiment permits a parallel or simultaneous ejection of the additive products contained in the tanks 5a, 5b. The upper part 21 of the cartridge 20 may be surmounted by a clamping ring. Said clamping ring may be replaced by any other means capable of permitting the clamping of the cartridge 20.

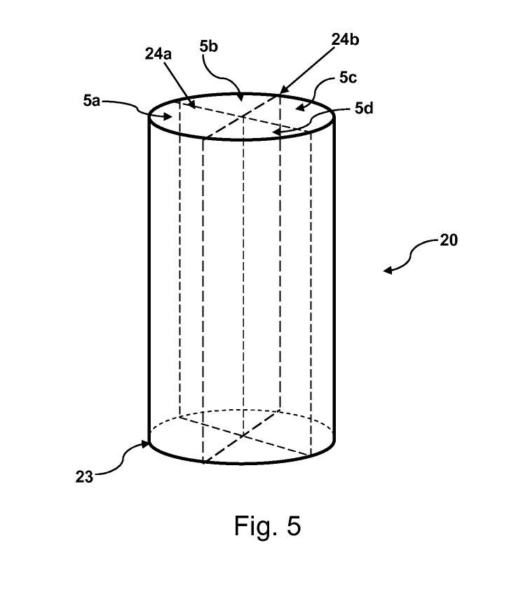

A further embodiment of the cartridge 20 according to the invention is detailed in FIG. 5. FIG. 5 shows a schematic view of a cartridge 20 comprising four tanks 5a-5d having a lateral wall at least partially common with the lateral wall 22 of said cartridge 20 and at least partially common with the lateral wall of at least one further tank 5 arranged inside the cartridge 20. Thus, the lateral wall of the tank 5a is partially common with that of the cartridge 20 and partially common with that of the tank 5b and 5d. The tanks 5a-5d are separated from one another by separating means 24a and 24b. Said lower sealed closing means 27 of said cartridge 20 is common with said lower sealed closing means 15 of the plurality of tanks 5a-5d arranged inside the cartridge 20. For example, said lower sealed closing means is a cap as disclosed above.

In embodiments, it may be expedient to separate the constituents of the fire-extinguishing product. Thus, said cartridge 20 may be used to separate the components contained in the fire-extinguishing product. According to an embodiment, at least one of the tanks 5a-5d of the cartridge 20 is capable of containing or contains a composition of agents forming a floating film (AFFF). For example, at least one of the tanks 5a-5d is capable of containing or contains one or more fluorinated or perfluorinated surfactants.

According to a third aspect, the invention relates to the use of one or more cartridges according to the invention in an extinguisher. The cartridge(s) may be arranged inside the cylinder 2 of the extinguisher 1 and/or on the ejection head 3 of the extinguisher 1. When the cartridge 20 is placed in the cylinder 2 of the extinguisher 1, the lower part 23 of said cartridge 20 is immersed in the fire-extinguishing product filling said cylinder 2. When the cartridge 20 is placed on the ejection head 3 of the extinguisher 1, the lower part 23 of said cartridge is connected to the discharge pipe 8 of the extinguisher. For example, the extinguisher may be a water or foam extinguisher. One or more cartridges may also be used to distribute in the plurality of tanks 5a, 5b or of the tanks 5a-5d of said cartridge 20 one or more additives capable of improving the properties of a fire-extinguishing product.

The embodiments disclosed herein are for a purely illustrative value and should not be considered as limiting. In a general manner, it is obvious to the person skilled in the art that the present invention is not limited to the examples illustrated and/or disclosed above. The embodiments each have novel features and include all the combinations thereof. The presence of reference numerals in the drawings may not be considered as limiting, including when said numerals are indicated in the claims. The use of the verbs “comprise”, “include”, “contain” or any other variant in addition to their conjugations, may not preclude in any way the presence of elements which are different from those mentioned. The use of the indefinite article “one” or the definite article “the” to introduce an element does not preclude the presence of a plurality of said elements.

In summary, embodiments provide an extinguisher 1 having a cylinder 2 capable of containing a fire-extinguishing product, and means for releasing the fire-extinguishing product from the cylinder and comprising at least one compressed gas cartridge, at least two tanks 5a, 5b each capable of containing at least one additive product, means for releasing the at least one additive product from each of the at least two tanks 5a, 5b, and mixing them with the fire-extinguishing product when releasing the fire-extinguishing product, and wherein at least one of the tanks 5a, 5b is removable relative to the extinguisher 1.

We claim:

1. An extinguisher comprising
a cylinder capable of containing a fire-extinguishing product, and
means for releasing the fire-extinguishing product from the cylinder and comprising at least one compressed gas cartridge,
at least two tanks, each capable of containing at least one additive product, and
means for releasing the at least one additive product from each of the at least two tanks and mixing with the fire-extinguishing product during the release of the fire-extinguishing product,
wherein at least one of the tanks is removable relative to the extinguisher.

2. The extinguisher according to claim 1, wherein the at least two tanks are arranged inside the cylinder.

3. The extinguisher according to claim 1, wherein the at least two tanks are disconnected.

4. The extinguisher according to claim 1, wherein the at least two tanks are provided with means to be connected together in a removable manner.

5. The extinguisher according to claim 4, wherein the at least two tanks are provided with means to be connected together by their end or by their lateral wall.

6. The extinguisher according to claim 1, wherein the extinguisher further comprises a cartridge and in that at least one of the tanks is arranged inside the cartridge.

7. The extinguisher according to claim 6, wherein said at least one of the tanks is removable relative to the cartridge.

8. The extinguisher according to claim 1, wherein said at least one of the tanks has a lateral wall connected to a further tank.

9. The extinguisher according to claim 8, wherein said at least one of the tanks has a lateral wall at least partially common with a lateral wall of the further tank.

10. The extinguisher according to claim 8, wherein said at least two tanks are arranged in a cartridge and have a lateral wall at least partially common with that of said cartridge, and at least partially common with a lateral wall of at least one further tank arranged inside the cartridge.

11. A cartridge for an extinguisher comprising a plurality of tanks, said tanks being capable of each containing one or more additives capable of improving the properties of a fire-extinguishing product, wherein at least one of the tanks is removable relative to the cartridge.

12. The cartridge according to claim 11, wherein the cartridge comprises at least two tanks provided with means to be connected together in a removable manner.

13. A cartridge for an extinguisher comprising a plurality of tanks, said tanks each being capable of containing one or more additives capable of improving the properties of a fire-extinguishing product, wherein at least one of the tanks has a lateral wall at least partially common with a lateral wall of at least one further tank arranged inside the cartridge.

14. The cartridge according to claim 13, wherein at least one of the tanks has a lateral wall at least partially common with a lateral wall of the cartridge and at least partially common with a lateral wall of at least one further tank arranged inside the cartridge.
